(19) United States
(12) Patent Application Publication
(10) Pub. No.: US 2015/0286117 A1
(43) Pub. Date: Oct. 8, 2015

(54) PORTABLE ELECTRONIC DEVICE MOUNTING SYSTEM

(71) Applicant: ERMI, Inc., Atlanta, GA (US)

(72) Inventors: Alexander SUNG, Powell, OH (US); Thomas P. BRANCH, Atlanta, GA (US); Edward DITTMAR, Marietta, GA (US); Eugene SUNG, Powell, OH (US)

(21) Appl. No.: 14/680,859

(22) Filed: Apr. 7, 2015

Related U.S. Application Data
(60) Provisional application No. 61/976,303, filed on Apr. 7, 2014.

(51) Int. Cl. G03B 17/56; A45F 3/00; F16M 13/02

(52) U.S. Cl. CPC G03B 17/561; F16M 13/022; A45F 3/00

(57) ABSTRACT

The present invention provides an improved portable electronic device mounting system for secure mounting of a camera or any other suitable portable electronic device. Generally described, the present invention includes a mounting system including a base mount, a device mount to which the device can be attached, and a tether. The mounting system is designed such that the device can be detached from the base, while being connected to the mount through a tether when sufficient force is applied. This precludes the potential loss of the device or possible harm to the user during any physical activity.

### CLAIM OF PRIORITY UNDER 35 U.S.C §119

The present Application for a Patent claims priority to Provisional Application No. 61/976,303 entitled “Portable Electronic Device Mounting System” filed Apr. 7, 2014, and assigned to the assignee hereof and hereby expressly incorporated by reference herein.

### TECHNICAL FIELD

This disclosure relates to a mounting system for portable electronic devices such as cameras.

### BACKGROUND

Action sports such as skiing, surfing, skydiving, SCUBA diving, and mountain climbing are greatly increasing in popularity due in part to increased awareness of said activities. This increased awareness is highly correlated with an enhanced ability to both document the activities with new video technology and share them through online video sharing sites.

As technology improves and portable electronic systems ultimately decrease in size, there arises an increased need for portability, security, and usability of the electronic device while the user maintains a “hands free” state. There exists an increased demand for users to be able to document themselves doing various activities as well as record his or her point of view during said activity.

Camera mounting systems, such as the tripod, have been utilized since the invention of the camera; however, as technology has increased the quality and durability of the camera while simultaneously decreasing the size, the usage requirements from the camera mounting systems have fundamentally changed. Small, portable video cameras and smartphones particularly, have given rise to the need for users to record in a “hands free” state.

Eventually, this led some to mount cameras to helmets, or other objects, utilizing adhesive tapes or screws. Oftentimes, simple adhesives lack the strength necessary to successfully secure an expensive electronic device to an object. Screws or bolts on the other hand risk breaking the mount or causing harm to the user in the event that a force were to strike the camera. For example, suppose that a skier is skiing down a mountain and is struck by a tree branch in the area of the mount. Due to the impact, the adhesive mount may detach resulting in the loss of the camera and the screw-attached mount might break or cause harm to the skier.

### BRIEF SUMMARY

Embodiments of the invention are directed to improved electronic device mounting systems for preventing the potential loss of the device or the possible harm to the user during any physical activity. An exemplary mounting system comprises: a “base mount” (otherwise described herein as a “mounting base”) and a “device mount” (otherwise described herein as a “mounting insert”) to which the portable device can be attached, and an “attachment member (otherwise described herein as a “tether”) that operatively couples the base mount to the device mount (e.g., the mounting base to the mounting insert) even when the base mount is not attached to the device mount (e.g., when the mounting base is not attached to the mounting insert), such as when the device mount becomes disassembled (e.g., disengaged) from the base mount.

In one embodiment the mounting insert (device mount) is designed such that the device (e.g., portable device) can be attached to the mounting insert (device mount) by the user. The mounting base (base mount) portion is preferably securely connected to an external support via screws, adhesives, straps, or other suitable attachment mechanism. The mounting insert (device mount) and mounting base (base mount) could be any suitable shape. The mounting base (base mount) may have a “base cavity” on its upper surface and the mounting insert (device mount) preferably fits securely into this cavity. In alternate embodiments the device mount may have a cavity and may fit over the base mount.

It is a further object of the present invention to design the secure fit such that the mounting insert (device mount) breaks free from the mounting base (base mount) when a certain threshold force is applied to the device. This threshold force is lower than the force required to separate the base mount from the external support and is also lower than the force required to separate the device from the device mount.

It is a further object of the present invention that in the event that the mounting insert (device mount) is knocked out of or off of the mounting base (base mount), the tether (otherwise described herein as an attachment member) operatively couples the device mount or the device to the base mount, the external support to which the base mount is mounted, another support, or the user himself/herself. When separation of the mounting insert (device mount) and the mounting base (base mount) occurs, the user may be able to grab and replace the portable device with its mounting insert (device mount) back into or on the mounting base (base mount).

In some embodiments, the outside edges and the bottom surface of the device mount are rectilinear, and the inside edges and the bottom surface of the cavity in the base mount are rectilinear. When the device mount is placed into the base mount, a suitable secure fit will ensue between the two. In other embodiments of the invention the device mount has the cavity and the device mount is placed over the base mount.

In some embodiments, at least one outside edge of the device mount and/or at least one inside edge of the cavity of the base mount are angled to create a taper lock. When the device mount is placed into the base mount, a specified angle will allow for a suitable secure fit between the two. In other embodiments of the invention the device mount has the cavity and the device mount is placed over the base mount. The taper lock can be tailored (e.g., change the angle, change the interference fit between the mounts, or the like) to control for the amount of shear force that is required to separate the device mount from the base mount. Different embodiments may require different configurations for optimal performance (e.g., protection of the device and safety of the user). A shallower angle on the taper lock may require more force to separate the device mount and base mount. Increasing the taper lock angle may decrease the force required to separate the device mount and base mount.

In some embodiments, the tapers on all the outer edges of the device mount and/or the base mount, as the case may be, are tapered. In some embodiments, the tapers on all the edges of the device mount are identical. In some embodiments, the tapers on all the edges of the base mount are tapered.

In some embodiments, the tapers on each of the outer edges of the device mount and/or the base mount are different.

In some embodiments, all the tapers on the inner edges of the cavity of base mount and/or the device mount are identical.

In some embodiments, each of the tapers on the inner edges of the cavity of the base mount and/or the device mount are different.

In some embodiments, tapers on the edges of the device mount and the corresponding edges of the base mount are identical. For example an insert in the device mount or the base mount corresponds with a cavity in the base mount or the device mount.

In some embodiments, tapers on the edges of the device mount and the corresponding edges of the base mount are different. For example an insert in the device mount or the based mount may have different tapers than a cavity in the base mount or the device mount.

In some embodiments, the secure fit between the device mount and the base mount comprises a friction or interference fit between at least one pair of opposite outside edges of one mount and at least one pair of corresponding opposite inside edges of the cavity of the opposite mount.

In some embodiments, the secure fit can be varied by the user, by varying the depth of insertion when the device mount is placed into or over the base mount.

In some embodiments the tapered edges of a first mount may be referred to as a male coupling and the tapered edges of a cavity on a second mount may be referred to as a female coupling, which together form a mounting coupling. Other types of couplings may include magnetic components on one or more of the mounts, detent components on one or more of the mounts, and/or frictional surfaces for operatively coupling device mount to the base mount. In some embodiments, the mounting system may comprise two or more of the mounting couplings, such as a primary mounting coupling and a secondary mounting coupling (otherwise described herein as an “auxiliary securement mechanism”) to make the process of attaching or reattaching the device mount into the base mount easier for the user.

In some embodiments, the auxiliary securement mechanism comprises the other types of couplings described above, or other couplings not specifically described herein.

In some embodiments, the device mount comprises one or more “device coupling members” or attachment clips to make the process of securely attaching the device to the device mount easier for the user.

In some embodiments, multiple devices can be attached to the device mount.

In some embodiments, the device mount comprises a “device interface guide” to enable a secure connection of the portable device to the device mount.

In some embodiments, the device mount and/or the base mount are made of a rigid plastic, metal, composite, foam, or other like material. While in other embodiments of the invention the device mount and/or the base mount are made of deformable plastic, metal, composite, foam, or other like material to facilitate an interference fit between the device mount and the base mount, or couplings thereof.

In some embodiments, the mounting system comprises a polygonal frustum shaped insert and cavity in either the device mount and/or the base mount.

In some embodiments, the polygonal frustum comprises a quadrilateral shaped frustum.

In some embodiments, the polygonal frustum comprises a hexagonal shaped frustum.

In some embodiments, the mounting system comprises a circular, oval, oblong, amoeba, or the like frustum shaped insert and cavity in the device mount and/or the base mount.

In some embodiments, the device mount can be oriented differently with respect to the base mount.

One embodiment of the invention is a portable device mounting apparatus. The apparatus comprises a base mount, wherein the base mount is configured for operative coupling with a support. The apparatus further comprises a device mount with a portable device coupling, wherein the portable device coupling is configured for operative coupling with a portable device. The apparatus further comprises a mounting coupling comprising a first coupling portion and a second coupling portion, wherein at least the first coupling portion or the second coupling portion comprises a tapered edge for creating a fit between the first coupling portion and the second coupling portion, and wherein the mounting coupling allows for engagement of the base mount and the device mount, and disengagement of the base mount and the device mount.

In further accord with an embodiment of the invention, the first coupling portion is a male coupling and the second coupling portion is a female coupling, and wherein the male coupling and the female coupling are configured for operative coupling with the base mount or the device mount.

In another embodiment of the invention, the male coupling is operatively coupled to the device mount and comprises the tapered edge, and the female coupling is operatively coupled to the base mount.

In yet another embodiment of the invention, the male coupling is operatively coupled to the device mount, and the female coupling is operatively coupled to the base mount and comprises the tapered edge.

In still another embodiment of the invention, the female coupling is operatively coupled to the device mount and comprises the tapered edge, and the male coupling is operatively coupled to the base mount.

In further accord with an embodiment of the invention, the female coupling is operatively coupled to the device mount, and the male coupling is operatively coupled to the base mount and comprises the tapered edge.

In another embodiment the invention further comprises an attachment member operatively coupled at a first end to the device mount or the portable device, and at a second end to at least one of the base mount, the support, or a user, wherein the attachment member operatively couples the base mount or the portable device to the base mount, the support, or the user during disengagement between the base mount and the device mount.

In yet another embodiment of the invention, the attachment member is a tether.

In still another embodiment of the invention, the tapered edge is configured for increasing a disengagement force to disengage the base mount and the device mount as the interface fit between the male coupling and the female coupling increases.

In further accord with an embodiment of the invention, the first coupling portion comprises a first shape and the second coupling portion comprises a second shape, wherein the first shape and the second shape allow for orientating the device mount with respect to the base mount in at least two different orientations.

In another embodiment of the invention, at least the first coupling portion or the second coupling portion is made from a deformable material to facilitate the fit as an interference fit.

In still another embodiment of the invention, the first coupling portion and the second coupling portion further comprise magnetic components, detent components, or frictional surfaces for operatively coupling the base mount to the device mount.

Another embodiment of the invention is a portable device mounting apparatus comprising a base mount, wherein the base mount is configured for operative coupling with a support. The invention further comprises a device mount with a portable device coupling, wherein the portable device coupling is configured for operative coupling with a portable device. The invention further comprises a mounting coupling comprising a first coupling portion and a second coupling portion, wherein the first coupling portion and the second coupling portion comprise magnetic components; and wherein the magnetic components are configured for operatively coupling the base mount to the device mount for engagement of the base mount and the device mount, and disengagement of the base mount and the device mount.

In further accord with an embodiment the invention comprises an attachment member operatively coupled at a first end to the device mount or the portable device, and at a second end to at least one of the base mount, the support, or a user, wherein the attachment member operatively couples the base mount or the portable device to the base mount, the support, or the user during disengagement between the base mount and the device mount.

In another embodiment of the invention, the attachment member is a tether.

In still another embodiment of the invention, the mounting coupling further comprises the first coupling portion with a first shape and operatively coupled to the base mount; the second coupling portion with a second shape and operatively coupled to the device mount; wherein the first shape and the second shape are configured for operatively coupling the device mount to the base mount in a plurality of orientations; and wherein the device mount is configured for disengagement from a first orientation and engagement in at least a second orientation.

In yet another embodiment of the invention, the first coupling portion and the second coupling portion further comprise detent components, or frictional surfaces for operatively coupling the base mount to the device mount.

In further accord with an embodiment of the invention, the first coupling portion or the second coupling portion comprises a tapered edge for creating a fit between the base mount and the device mount.

In another embodiment of the invention, at least the first coupling portion or the second coupling portion is made from a deformable material to facilitate the fit as an interference fit.

Another embodiment of the invention comprises a portable device mounting apparatus, comprising a base mount, wherein the base mount is configured for operative coupling with a support. The invention further comprises a device mount with a portable device coupling, wherein the portable device coupling is configured for operative coupling with a portable device. The invention further comprises a mounting coupling comprising a first coupling portion and a second coupling portion, wherein the first coupling portion and the second coupling portion comprise detent components operatively coupled to the base mount and the device mount, and wherein the detent components are configured for operatively coupling the base mount to the device mount for engagement of the base mount and the device mount and disengagement of the base mount and the device mount.

In further accord with an embodiment the invention comprises an attachment member operatively coupled at a first end to the device mount or the portable device, and at a second end to at least one of the base mount, the support, or a user, wherein the attachment member operatively couples the base mount or the portable device to the base mount, the support, or the user during disengagement between the base mount and the device mount.

In another embodiment of the invention, the attachment member is a tether.

In yet another embodiment of the invention, the mounting coupling further comprises the first coupling portion with a first shape and operatively coupled to the base mount; the second coupling portion with a second shape and operatively coupled to the device mount; wherein the first shape and the second shape are configured for operatively coupling the device mount to the base mount in a plurality of orientations; and wherein the device mount is configured for disengagement from a first orientation and engagement in at least a second orientation.

In still another embodiment of the invention the first coupling portion and the second coupling portion further comprise magnetic components, or frictional surfaces for operatively coupling the base mount to the device mount.

In further accord with an embodiment of the invention the first coupling portion or the second coupling portion comprises a tapered edge for creating a fit between the base mount and the device mount.

In another embodiment of the invention, at least the first coupling portion or the second coupling portion is made from a deformable material to facilitate the fit as an interference fit.

Another embodiment of the invention is a portable device mounting apparatus comprising a base mount, wherein the base mount is configured for operative coupling with a support. The invention further comprises a device mount with a portable device coupling, wherein the portable device coupling is configured for operative coupling with a portable device. The invention further comprises a mounting coupling comprising a first coupling portion with a first shape and operatively coupled to the base mount and a second coupling portion with a second shape and operatively coupled to the device mount; wherein the first shape and the second shape are configured for operatively coupling the device mount to the base mount in a plurality of orientations; and wherein the device mount is configured for disengagement from a first orientation and engagement in at least a second orientation.

In further accord with an embodiment the invention further comprises an attachment member operatively coupled at a first end to the device mount or the portable device, and at a second end to at least one of the base mount, the support, or a user, wherein the attachment member operatively couples the base mount or the portable device to the base mount, the support, or the user during disengagement between the base mount and the device mount.

In another embodiment of the invention, the attachment member is a tether.

In yet another embodiment of the invention, the first coupling portion and the second coupling portion further comprise detent components, magnetic components, or frictional surfaces for operatively coupling the base mount to the device mount.

In still another embodiment of the invention, the first coupling portion or the second coupling portion comprises a tapered edge for creating a fit between the base mount and the device mount.

In further accord with an embodiment of the invention, at least the first coupling portion or the second coupling portion is made from a deformable material to facilitate the fit as an interference fit.

To the accomplishment of the foregoing and the related ends, the one or more embodiments comprise the features hereinafter fully described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, wherein:

FIG. 1A illustrates a front view of the mounting system, in accordance with one embodiment of the invention;

FIG. 1B illustrates a perspective view of the mounting system, in accordance with one embodiment of the invention;

FIG. 2A illustrates a perspective view of the device mount assembled with the base mount, in accordance with one embodiment of the invention;

FIG. 2B illustrates a perspective exploded view of the device mount disassembled from the base mount, in accordance with one embodiment of the invention;

FIG. 3A illustrates a cross-sectional front view of the device mount assembled with the base mount, in accordance with one embodiment of the invention;

FIG. 3B illustrates a cross-sectional front view of the device mount disassembled from the base mount, in accordance with one embodiment of the invention;

FIG. 4 illustrates a perspective view of the portable device mounting system with a particular shape, device coupling members, and a device interface guide, in accordance with one embodiment of the invention;

FIG. 5 illustrates a perspective view of the portable device mounting system with a particular shape, device coupling members, and a device interface guide, in accordance with one embodiment of the invention;

FIG. 6A illustrates a perspective view of the portable device mounting system with the device mount assembled with the base mount and illustrating a secondary or an auxiliary securement mechanism, in accordance with one embodiment of the invention;

FIG. 6B illustrates a perspective exploded view of the portable device mounting system with the device mount disassembled with the base mount and illustrating a secondary or an auxiliary securement mechanism, in accordance with one embodiment of the invention;

FIG. 7A illustrates a cross-sectional front view of the portable device mounting system with the device mount assembled with the base mount and illustrating a secondary or an auxiliary securement mechanism, in accordance with one embodiment of the invention; and

FIG. 7B illustrates a cross-sectional front exploded view of the portable device mounting system with the device mount disassembled with the base mount and illustrating a secondary or an auxiliary securement mechanism, in accordance with one embodiment of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout. Reference is now made to the figures, in which like elements indicate like elements throughout the several views. The application will be discussed by reference to several different embodiments, which may share inventive concepts or alternately may each include individual inventive concepts.

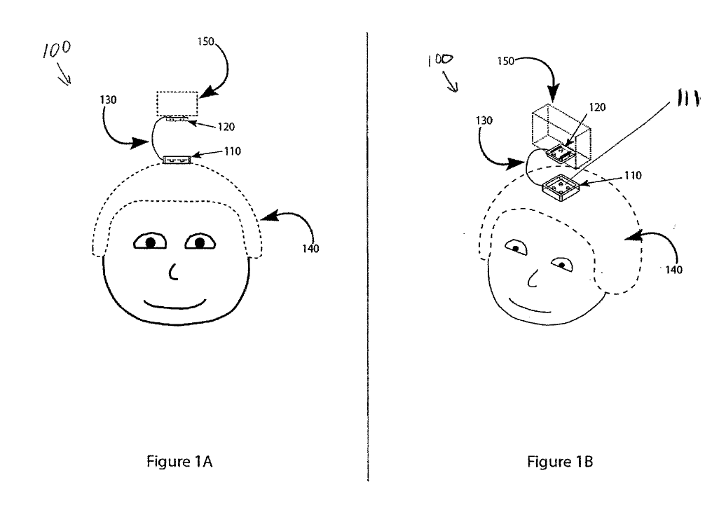

Generally, FIGS. 1A-1B illustrate an embodiment of the portable electronic device mounting system 100. FIG. 1A represents a front view and FIG. 1B represents an isometric view of the first embodiment. The base mount 110 is connected to a support, such as a user interface member 140, for example equipment member (e.g., bike member, board member, ski member, helmet, padding for another body part, harness, or any other like support structure) and the device mount 120 is connected to a portable device 150 (such as a camera, or other like device) with the device mount operatively coupled to the base mount by an attachment member 130 (e.g., tether) when the device mount is disassembled from the base mount. The device mount and the base mount may be assembled through an operative coupling by use of a mounting coupling, which will be explained in further detail later.

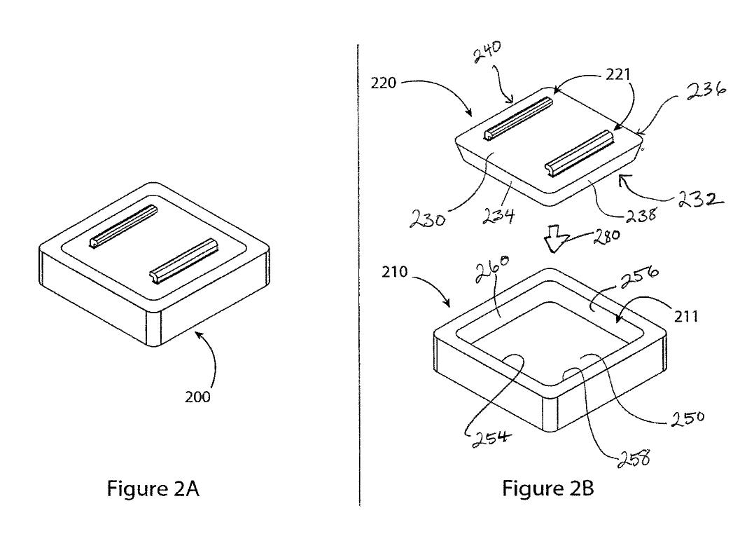

FIGS. 2A-2B illustrate isometric views of one embodiment of the portable device mounting system. FIG. 2A represents the assembled mounting system 200 and FIG. 2B represents the exploded dissembled view of the assembly 200. The assembly 200 comprises a base mount 210 and a device mount 220 with device coupling members 221 and a base cavity 211.

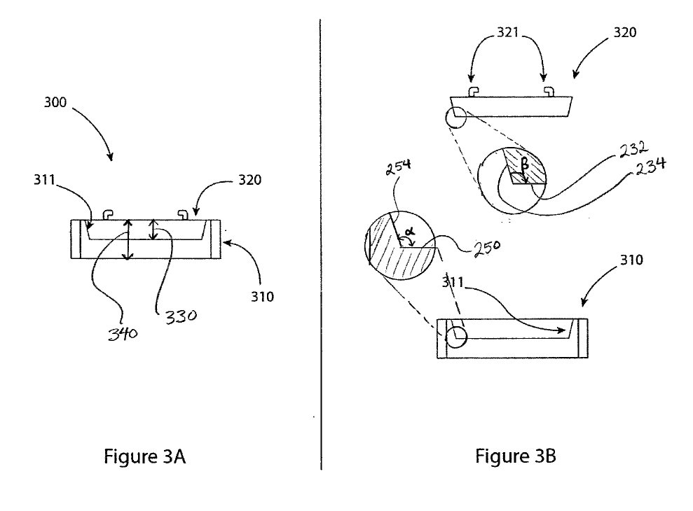

FIGS. 3A-3B illustrate cross-sectional front views of FIGS. 2A-2B of the portable device mounting system. FIG. 3A represents the assembled mounting system 300 and FIG. 3B represents the exploded dissembled view of the assembly 300. The assembly 300 comprises a base mount 310 and a device mount 320 with device coupling members 321 and a base cavity 311.

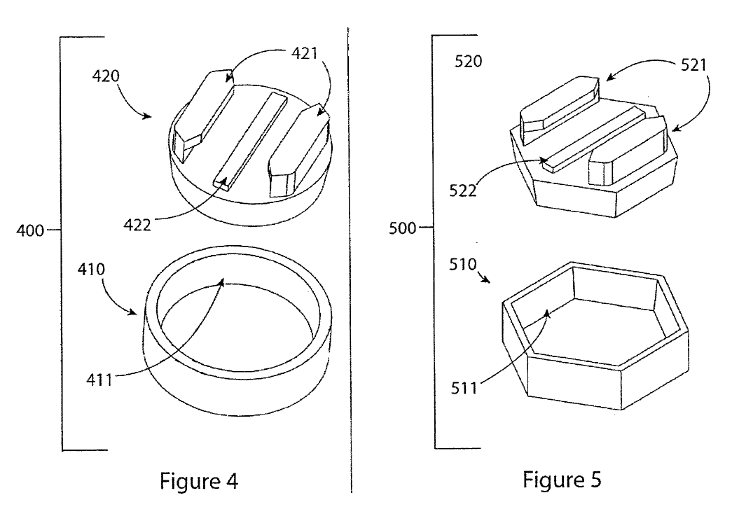

FIG. 4 illustrates the isometric view of another embodiment of the portable device mounting system, 400. The system 400 comprises a base mount 410 and a device mount 420 with device coupling members 421, a base cavity 411 and a device interface guide 422. The device mounting systems 400 comprising a generally rounded shape.

FIG. 5 illustrates the isometric view of another embodiment of the portable device mounting system, 500. The system 500 comprises a base mount 510 and a device mount 520 with device coupling members 521, a base cavity 511 and a device interface guide 522. The device mounting system 500 comprising a generally hexagonal shape.

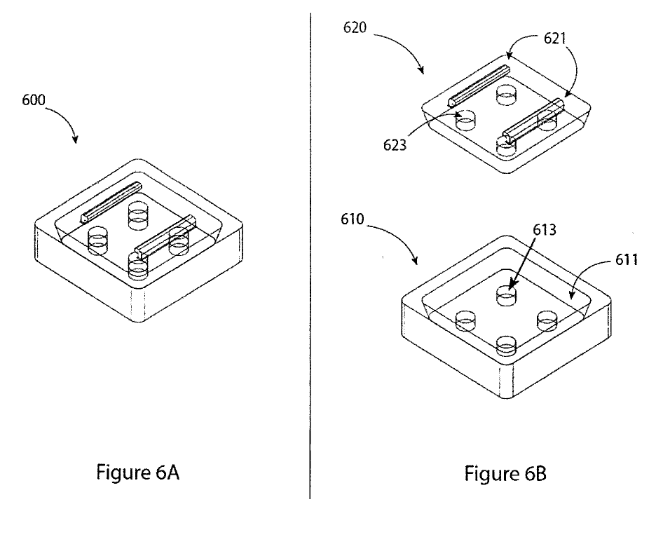

FIGS. 6A-6B illustrate isometric views of another embodiment of the portable device mounting system. FIG. 6A represents the assembled mounting system 600 and FIG. 6B represents the exploded dissembled view of the assembly 600. The assembly 600 comprises a base mount 610 and a device mount 620 with device coupling members 621, a base cavity 611 and auxiliary securement mechanisms 613 & 623.

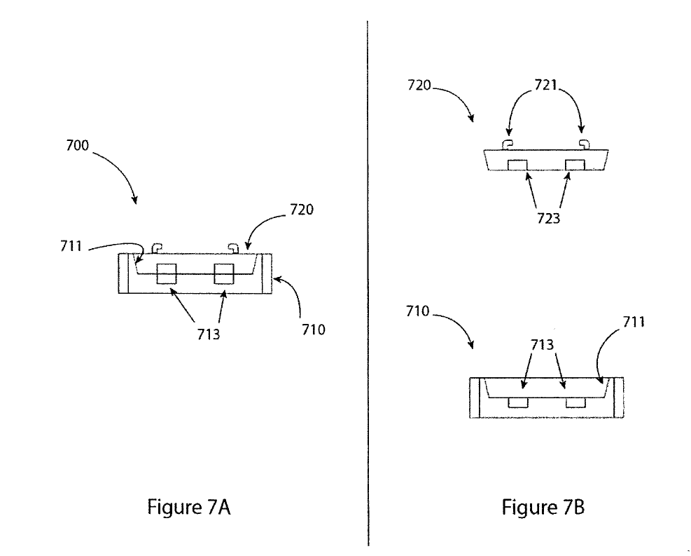

FIGS. 7A-7B illustrate front views of the embodiment of the portable device mounting system illustrated in FIGS. 6A-6B. FIG. 7A represents the assembled mounting system 700 and FIG. 7B represents the exploded disassembled view of the assembly 700. The assembly 700 comprises a base mount 710 and a device mount 720 with device coupling members 721, a base cavity 711 and auxiliary securement mechanisms 713 & 723.

Returning to FIGS. 1A and 1B, these figures illustrate one embodiment of the portable device mounting system 100 that couples the portable device 150 and a user interface member 140. The device 150 can be any suitable portable device the user wishes to mount, such as a camera. The user interface member 140 can be any suitable object to mount the camera such as a helmet, a strap, an article of clothing etc. In other embodiments, it should be understood that the portable device mounting system 100 may be utilized to couple the portable device 150 to any type of support that is associated with the user, such as the user's equipment (e.g., equipment the user is riding or controlling, operating manually, operatively automatically, operating through a software program, or the like), such as, but not limited to a bike, car, motorized vehicle, manually operated vehicle, or other vehicle, drone, remote controlled device, tri-pod, or any other like support structure. The base mount 110 is secured to the user interface 140, or other type of support structure described above, using an adhesive, screws, a universal screw mount, strap, rivets, mechanical means, magnet(s), fastener, or another suitable attachment mechanism. It should be understood that in some embodiments of the invention the base mount 110 may be a separate mount that is removeably operatively coupled to the support. However, in other embodiments of the invention the base mount 110 may be integrally operatively coupled to the support, such that the base mount 110 is a part of the support, and as such the device mount 120 may be operatively coupled to the support directly through a base mount 110 that is formed within the support.

The base mount 110 and a device mount 120 are connected using an attachment member 130 that operatively couples the base mount 110 to the device mount 120 even when the base mount 110 is disassembled from the device mount 120. The attachment member 130 could be a tether made of a plastic, metal, composite, foam, or other like material cable or wire or coated cable or wire, or any other suitable attachment mechanism.

In other embodiments, which are not specifically illustrated in the drawings, the attachment member 130 (e.g., tether) may have a first end operatively coupled to the device mount 120 and/or the device itself, and instead of or in addition to the second end being operatively coupled to the base mount 110, the attachment member 130 (e.g., tether) may be operatively coupled to the support on which the base mount 110 is operatively coupled, such as the user interface member 140. For example, when the base mount 110 is operatively coupled integrally with the support (e.g., is formed as a part of the support) the attachment member 130 may be operatively coupled to the device mount 120 or the device on a first end, and to the support on a second end. In still other embodiments of the invention, instead of or in addition to being operatively coupled to the support, the attachment member 130 may be operatively coupled directly to a body part of the user, such as the user's wrist, arm, leg, head, neck, back, or other like body part, either directly to the user or through the user's clothing or other article or device attached to the user. As such, the attachment member 130 may operatively couple the device or the device mount to the base mount, the support to which the base mount is operatively coupled or another support which is not operatively coupled to the base mount, or to the user.

The base mount 110 (e.g., which is also referred to herein as a mounting base), and the device mount 120 (e.g., which is also referred to herein as a mounting insert) may be operatively coupled for assembly (e.g., engagement) or disassembly (e.g., disengagement) through a mounting coupling. The mounting coupling has a first coupling portion and a second coupling portion, and in some embodiments, the first coupling portion is a male coupling (e.g. an insert) and the second coupling portion is a female coupling (e.g., a cavity, aperture, or the like). The male coupling may be operatively coupled to either the device mount or the base mount, and as such the opposing female coupling is operatively coupled to the base mount or the device mount. The male coupling, in some embodiments, may be or includes one or more protrusions, for example a convex frustrum of various shapes, and the female coupling may be or include one or more cavities, for example a concave frustrum. The male coupling (e.g., the convex frustrum) and the female coupling (e.g., the concave frustrum) may be formed of various shapes, typically corresponding to each other in order to facilitate coupling to one another.

Referring back to FIGS. 1A and 1B, the device mount 120 is illustrated as a convex quadrilateral frustum. The device mount 120 has top and bottom surfaces, front and back opposing outer edges and left and right opposing outer edges. The bottom surface and the edges of the device mount 120 are rectilinear. The top surface of the device mount 120 is designed such that the device 150 can be attached to the device mount 120 by the user. The base mount 110 can be made of any suitable shape. The base mount 110 has a base cavity 111 (shown in FIG. 1B) shaped as a concave quadrilateral frustum centered on its top surface. The base cavity 111 is configured to receive and removably operatively couple (e.g., assemble, attach, engage, or the like) with the device mount 120. The base cavity 111 has a bottom surface, front and back opposing inner edges and left and right opposing inner edges, such that the bottom surface and the inner edges are rectilinear. In some embodiments, the depth of the base cavity 111 is less than, greater than, or equal to the depth of the base mount 110, and in some embodiments the base cavity 111 is an aperture through the base mount 110. In some embodiments, one or more of the dimensions of the base mount 110 and/or the dimensions of the base cavity 111 are nominally greater than the dimensions of the corresponding portions of the device mount 120 so as to create a friction (e.g., interference, press, and/or the like) fit between the device mount 120 and the base mount 110 when the device mount 120 is placed into the base cavity 111. The friction fit is created when the device mount 120 is coupled with the base mount 110. The friction fit is created between at least one pair of opposing outer edges of the device mount 120 and the corresponding pair of opposing inner edges of the base cavity 111. It should be understood that in some embodiments the female coupling portion, such as the cavity, is located on the device mount 120 and the male coupling portion, such as the insert, is located on the base mount 110, and is operatively coupled to each other as described herein.

The friction fit is designed such that the device mount 120 breaks free from the base mount 110 when a certain threshold force is applied to the device 150. This threshold force is lower than the force required to separate the base mount 110 from the user interface 140, or other like support, and is also lower than the force required to separate the device 150 from the device mount 120. When the device mount 120 and the base mount 110 separate, the device 150 and device mount 120 remain connected to the base mount 110, the support, or the user through the attachment member 130. The user may be able to grab and replace the device 150 with its device mount 120 back into, over, or on the base mount 110. Further, in some embodiments, the friction fit and the threshold force can be varied by the user, by varying the depth of insertion when the device mount 120 is placed into, over, or on the base mount 110. For example, when at least one of the edges of the male coupling or the female coupling are tapered, the farther the male coupling is inserted into the female coupling the greater the friction fit will be (e.g., the greater the interference between the mounts). As such, greater force will be required to disengage the device mount 120 from the base mount 110.

In some embodiments of the invention illustrated by FIGS. 2A and 2B, the assembled mounting system 200 may be made of a rigid plastic, metal, composite, foam, or other like material. However, in other various embodiments, the material (e.g., plastic, metal, composite, foam, or other like material) is pliable or deformable to a degree that assists the friction fit. For example, in some embodiments, the base mount 210 may have a greater degree of deformability than the device mount 220 such that the device mount 220 forces the base mount 210 to deform to supplement the friction fit between the two mounts. In other embodiments of the invention the device mount 220 may have a greater degree of deformability than the based mount 210 to supplement the friction fit between the two mounts.

Referring back to FIG. 2B, in one embodiment a base cavity 211 defined by the base mount 210 and the similarly shaped lower portion of the device mount 220 have the same or similar shape to mate together the base mount 210 and the device mount 220. The device mount 220 may comprise a male coupling defined as a convex quadrilateral frustum. The male coupling may have a top and bottom surfaces 230 and 232, respectively, front and back opposing outer edges 234 and 236, respectively, and left and right opposing outer edges 238 and 240, respectively. In other embodiments the male coupling may have any number of outer edges, including one or more outer edges that may be flat and/or curved.

The base mount 210 can be made of any shape. The base mount 210 may have a female coupling that is a base cavity 211 shaped as a concave quadrilateral frustum similar to the shape of the male coupling of the device mount 220 centered on its top surface 230. The base cavity 211 has a bottom surface 250, front and back opposing inner edges 252 and 254, respectively, and left and right opposing inner edges 258 and 260, respectively. In other embodiments the female coupling may have any number of inner edges, including one or more inner edges that may be flat and/or curved.

In the embodiment shown in FIG. 2B, when the device mount 220 is moved in the direction of arrow 280 so that it couples with the base mount 210, the front outer edge 238 of the device mount 220 mates with the front inner edge 258 of the base mount 210. Likewise, the back outer edge 236 of the device mount 220 mates with the back inner edge 256 of the base mount 210, the left outer edge 238 of the device mount 220 mates with the left inner edge 258 of the base mount 210, and the right outer edge 240 of the device mount 220 mates with the right inner edge 260 of the base mount 210. In various embodiments, less than all the corresponding edges of the device mount 220 and the base mount 210 mate with one another. For example, in some quadrilateral embodiments, only two (2) of the edges mate with one another. This is accomplished in some embodiments by configuring only the front and back edges to mate while the right and left edges are not configured to mate, or alternatively, configuring only the right and left edges to mate while the front and back edges are not configured to mate.

Referring to FIGS. 3A and 3B, cross-sectional views of the embodiment of FIGS. 2A and 2B are shown. In the embodiment shown, the depth 330 of the base cavity 211, 311 is less than the depth 340 of the base mount 210, 310. As noted above, in some embodiments, the base cavity 211, 311 may extend through the entire depth 340 of the base mount 210, 310, thereby forming an aperture.

One or more of the inner edges 254, 256, 258 and 260 of the base cavity 211, 311 may have a taper with a taper angle α defined as the angle between the bottom surface 250 and an edge (such as edge 254) of the cavity 211, 311. Each of the edges 254, 256, 258 and/or 260 can have the same or a different taper angle α.

Further, one or more of the outer edges 234, 236, 238 and 240 of the device mount 220, 320 are tapered with a taper angle β defined as the angle between the bottom surface 232 and an edge (such as edge 234) of the insert 220, 320. Each of the edges 234, 236, 238 and/or 240 can have the same or a different taper angle β. In various embodiments, taper angle α can be ninety (90) degrees (rectilinear) or greater (tapered). Similarly, in various embodiments, taper angle β can be ninety (90) degrees (rectilinear) or greater (tapered). In various embodiments, an inner edge 254, 256, 258 or 260 of the cavity 211, 311 can have the same or a different taper angle α as the corresponding taper angle β of the outer edge 234, 236, 238 or 240 of the device mount 220, 320. In still other embodiments the angles are the same, but the female coupling, such as the cavity, may be located on the device mount 320 while the male coupling, such as the insert, may be located on the base mount 310.

In some embodiments, the base mount 310 and the device mount 320 are coupled by a friction fit generated between the one or more inner edges of the base mount 310 and one or more corresponding outer edges of the device mount 320. Referring back to FIG. 2B, a portable electronic device, such as a camera, is secured to the device mount 220 using the device coupling members 221. The design of the portable device mounting system allows for the device mount 220 to break free from the base mount 210 without damaging either structure when the applied force is greater than the threshold force of the friction fit. This allows for the base mount 210 to remain attached to an object (such as the helmet of a wearer) while the portable device can remain attached to the device mount 220, which breaks free to protect the portable device as well as to protect the user of the system. The device mount 220 can be replaced after it is released. This is an easy process involving only pressing the device mount 220 back into the base mount 210. The configuration of the base mount 210 and the device mount 220 in this embodiment allows for the portable device to be selectively pointed in four directions (each side of the square). In one use of this embodiment, this would allow for a camera to film in a point of view manner, to also film what is happening behind the user, or to film on either side of the user's line of sight.

Another embodiment of the invention is represented by FIG. 4, which illustrates the isometric view of the portable device mounting system 400 (shown disassembled). The assembly can be made of a rigid for deformable plastic, metal, composite, foam, or other like material. The device mounting system 400 is comprised of a device mount 420 with a circular frustum shape, and a similar shaped base mount 410. The device mount 420 has top and bottom surfaces and an outer curved edge. The base mount 410 has a cavity with a bottom surface and an inner curved edge. The base mount 410 and the device mount 420 can have tapered edges, which create a friction fit between male and female coupling walls of the two mounts similar to that described above. The taper angle is defined for the male coupling insert as the angle between the bottom surface and the outer edge measured in a plane perpendicular to the bottom surface. The taper angle is defined for the female coupling cavity as the angle between the bottom surface and the inner edge measured in a plane perpendicular to the bottom surface. The device mount and the base mount can have the same or different taper angles. The taper angles can be 90 degrees or greater for the cavity and 90 degree or less for the insert. The device coupling members 421 and the device interface guide 422 enable a secure connection between the portable device and the device mount 420. This embodiment is similar to the previous embodiments and preserves the benefits of the previous embodiments, such as the breakaway nature of the device mount along with the method of inserting the device mount 420 back into the base mount 410 after a force separates them. However, the portable device mounting system 400 illustrated in FIG. 4 allows for orientation of the portable device in any orientation within the plane on which the portable device mounting system 400 is located (e.g., 360 degrees because of the circular shape).

FIG. 5 illustrates another embodiment of the invention similar to previous embodiments described herein. FIG. 5 is an isometric view of a portable device mounting system 500, shown disassembled. This embodiment is another possible device mounting system 500 comprised of a hexagonal base mount 510 and a similarly shaped frustum device mount 520. As in the previous embodiments, the base mount 510 and the device mount 520 can have tapered edges, with similar definitions of the taper angles. The taper angles for each of the outer edges of the device mount 520 and the corresponding inner edges of the cavity in the base mount 510 can be identical or different. The dimensions of the hexagonal frustum on the device mount 520 and the cavity of the base mount 510 are such that when operatively coupled they create a friction fit between at least two opposing edges. The device coupling members 521 and the device interface guide 522 enable secure connection of the portable device to the device mount 520. The hexagonal configuration of the female coupling (e.g., cavity) of the base mount 510 and the male coupling (e.g., insert) of the device mount 520 allow for the portable device to be positioned in six different radial orientations.

As previously discussed any shapes may be utilized for the base mount 510 and the device mount 520 (e.g., or the male and female couplings within) to allow for operative coupling of the mounts together. As such, different mounting systems may be able to be mounted in different orientations based on the number of edges, such as but not limited to, 1, 2, 3, 4, 5, 6, 7, 8, 9, 10, or other like orientations up to any orientation within 360 degrees (e.g., a circular mount). Moreover, in other embodiments of the invention the base mount 510 and/or the device mount 520 may allow for orientation of the portable device in other planes, such as through a ball and socket joint, or other like joints that allow for positioning of the portable device in other orientations along different planes.

FIGS. 6A and 6B are isometric views of another embodiment of the mounting system 600, while FIGS. 7A and 7B provide cross-sectional front views of the mounting system 600, 700 illustrated in FIGS. 6A and 6B. As in the previous embodiments, the assembled mounting system 600, 700 is comprised of a base mount 610, 710 having a base cavity 611, 711, and a device mount 620, 720. In this embodiment, there is an auxiliary securement mechanism 613, 713 (otherwise described as a secondary coupling). The purpose of the auxiliary securement mechanism 613, 713 is to supplement the friction fit so as to increase the holding force between the base mount 610, 710 and the device mount 620, 720 and to make the process of reattaching the device mount 620, 720 into the base mount easier for the user. This auxiliary securement mechanism 613, 713 & 623, 723 could be a system of magnets that are embedded into the base mount 610 and the device mount 620, respectively. In some embodiments of the invention the magnetic force of the magnetic components within the device mount and/or the base mount may be adjustable to adjust the strength of the magnets, and thus, to adjust the threshold force needed to overcome the coupling of the device mount to the base mount through the use of the magnets. For example, in some embodiments the magnetic components may be interchangeable within the device mount and/or the base mount to allow for the use of different strength magnets, or a different number of magnets, within the present invention. A different number of magnets may be inserted into the device mount and/or the base mount at different locations (e.g., stacked on top of each other or placed in apparatus within the mounts adjacent to one another). In other embodiments of the invention the distance within the mounts at which the magnets are located may be adjustable to change the strength of the coupling between the device mount and the base mount. For example, the magnetic components may be positioned within the mounts (e.g., within the male coupling and/or the cavity of the female coupling) at different locations or depths in order to adjust the force that the magnets exert on one another. In other embodiments, other material may be added or removed from the location of the magnets to increase or decrease the strength of the coupling between device mount and the base mount through the use of the magnets. In some embodiments, an adjustment knob, lever, button, or other like adjustment feature may be utilized to change the strength of the magnets, for example by changing the location of the magnets, the number of magnets used, or the position of other material relative to the magnets in the mounts.

In other embodiment the depth of the base cavity 111 is less than the depth of the base mount 110, and the auxiliary securement mechanism 613, 713 & 623, 723 may be pegs or fingers that fit into apertures within the cavity 611, 711.

In other embodiments, not specifically illustrated in the figures, the auxiliary securement mechanism may further include a universal screw mount as the mounting coupling or a part of the mounting coupling. For example, a screw mount within a portable device (e.g., a camera) may be adapted with a universal screw mount. As such, a mount of the present invention may be coupled to a current screw mount within a portable device or support structure in order to create the quick connect or disconnect features of the present invention. For example, the device mount may utilize a universal screw mount to be operatively coupled to a camera, and/or the base mount may utilize a universal screw mount to be operatively coupled to a tri-pod. As such, the present invention may be utilized with equipment that is already being used in order to provide the same benefits as described with respect to the present invention. Moreover, the attachment member 130 may also be utilized with standard equipment, such as tri-pod, to present a portable device from falling off the tri-pod, but also allowing the portable device to disengage from the tri-pod upon something impacting the portable device. As such, in some embodiments of the invention the tri-pod may be the support structure (e.g., support member) with a detachable base mount or an integral base mount operatively coupled to the tri-pod.

It should be understood that the auxiliary securement mechanisms (e.g., the secondary mechanism) may be used as the primary mechanism in some embodiments of the invention, thus replacing the tapered edges described herein. As such, the mounting couplings described herein (e.g., the male coupling and the female coupling) may be the insert and cavity described herein with or without the tapered edges, or it may be the magnets, detent (e.g., pegs or fingers, and apertures), frictional surfaces, universal screw mount, or other like coupling device not specifically described herein. Moreover, any of these or a combination of these mounting couplings may be used as a primary coupling and/or secondary couplings.

While certain exemplary embodiments have been described herein, and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A portable device mounting apparatus, comprising:
a base mount, wherein the base mount is configured for operative coupling with a support;
a device mount with a portable device coupling, wherein the portable device coupling is configured for operative coupling with a portable device;
a mounting coupling comprising:
a first coupling portion;
a second coupling portion;
wherein at least the first coupling portion or the second coupling portion comprises a tapered edge for creating a fit between the first coupling portion and the second coupling portion; and
wherein the mounting coupling allows for engagement of the base mount and the device mount, and disengagement of the base mount and the device mount.

2. The portable device mounting apparatus of claim 1, wherein the first coupling portion is a male coupling and the second coupling portion is a female coupling, and wherein the male coupling and the female coupling are configured for operative coupling with the base mount or the device mount.

3. The portable device mounting apparatus of claim 2, wherein the male coupling is operatively coupled to the device mount and comprises the tapered edge, and the female coupling is operatively coupled to the base mount.

4. The portable device mounting apparatus of claim 2, wherein the male coupling is operatively coupled to the device mount, and the female coupling is operatively coupled to the base mount and comprises the tapered edge.

5. The portable device mounting apparatus of claim 2, wherein the female coupling is operatively coupled to the device mount and comprises the tapered edge, and the male coupling is operatively coupled to the base mount.

6. The portable device mounting apparatus of claim 2, wherein the female coupling is operatively coupled to the device mount, and the male coupling is operatively coupled to the base mount and comprises the tapered edge.

7. The portable device mounting apparatus of claim 1, further comprising:
an attachment member operatively coupled at a first end to the device mount or the portable device, and at a second end to at least one of the base mount, the support, or a user, wherein the attachment member operatively couples the base mount or the portable device to the base mount, the support, or the user during disengagement between the base mount and the device mount.

8. The portable device mounting apparatus of claim 7, wherein the attachment member is a tether.

9. The portable device mounting apparatus of claim 1, wherein the tapered edge is configured for increasing a disengagement force to disengage the base mount and the device mount as the interface fit between the male coupling and the female coupling increases.

10. The portable device mounting apparatus of claim 1, wherein the first coupling portion comprises a first shape and the second coupling portion comprises a second shape, wherein the first shape and the second shape allow for orientating the device mount with respect to the base mount in at least two different orientations.

11. The portable device mounting apparatus of claim 1, wherein at least the first coupling portion or the second coupling portion is made from a deformable material to facilitate the fit as an interference fit.

12. The portable device mounting apparatus of claim 1, wherein the first coupling portion and the second coupling portion further comprise magnetic components, detent components, or frictional surfaces for operatively coupling the base mount to the device mount.

13. A portable device mounting apparatus, comprising:
a base mount, wherein the base mount is configured for operative coupling with a support;
a device mount with a portable device coupling, wherein the portable device coupling is configured for operative coupling with a portable device;
a mounting coupling comprising:
a first coupling portion;
a second coupling portion;
wherein the first coupling portion and the second coupling portion comprise magnetic components; and
wherein the magnetic components are configured for operatively coupling the base mount to the device mount for engagement of the base mount and the device mount, and disengagement of the base mount and the device mount.

14. The portable device mounting apparatus of claim 13, further comprising:
an attachment member operatively coupled at a first end to the device mount or the portable device, and at a second end to at least one of the base mount, the support, or a user, wherein the attachment member operatively couples the base mount or the portable device to the base mount, the support, or the user during disengagement between the base mount and the device mount.

15. The portable device mounting apparatus of claim 14, wherein the attachment member is a tether.

16. The portable device mounting apparatus of claim 13, wherein the mounting coupling further comprises:
the first coupling portion with a first shape and operatively coupled to the base mount;
the second coupling portion with a second shape and operatively coupled to the device mount;
wherein the first shape and the second shape are configured for operatively coupling the device mount to the base mount in a plurality of orientations; and
wherein the device mount is configured for disengagement from a first orientation and engagement in at least a second orientation.

17. The portable device mounting apparatus of claim 13, wherein the first coupling portion and the second coupling portion further comprise detent components, or frictional surfaces for operatively coupling the base mount to the device mount.

18. The portable device mounting apparatus of claim 13, wherein the first coupling portion or the second coupling portion comprises a tapered edge for creating a fit between the base mount and the device mount.

19. The portable device mounting apparatus of claim 18, wherein at least the first coupling portion or the second coupling portion is made from a deformable material to facilitate the fit as an interference fit.

20. A portable device mounting apparatus, comprising:
a base mount, wherein the base mount is configured for operative coupling with a support;
a device mount with a portable device coupling, wherein the portable device coupling is configured for operative coupling with a portable device;
a mounting coupling comprising:
a first coupling portion;
a second coupling portion;
wherein the first coupling portion and the second coupling portion comprise detent components operatively coupled to the base mount and the device mount; and
wherein the detent components are configured for operatively coupling the base mount to the device mount for engagement of the base mount and the device mount and disengagement of the base mount and the device mount.

21. The portable device mounting apparatus of claim 20, further comprising:
an attachment member operatively coupled at a first end to the device mount or the portable device, and at a second end to at least one of the base mount, the support, or a user, wherein the attachment member operatively couples the base mount or the portable device to the base mount, the support, or the user during disengagement between the base mount and the device mount.

22. The portable device mounting apparatus of claim 21, wherein the attachment member is a tether.

23. The portable device mounting apparatus of claim 20, wherein the mounting coupling further comprises:
the first coupling portion with a first shape and operatively coupled to the base mount;
the second coupling portion with a second shape and operatively coupled to the device mount;
wherein the first shape and the second shape are configured for operatively coupling the device mount to the base mount in a plurality of orientations; and
wherein the device mount is configured for disengagement from a first orientation and engagement in at least a second orientation.

24. The portable device mounting apparatus of claim 20, wherein the first coupling portion and the second coupling portion further comprise magnetic components, or frictional surfaces for operatively coupling the base mount to the device mount.

25. The portable device mounting apparatus of claim 20, wherein the first coupling portion or the second coupling portion comprises a tapered edge for creating a fit between the base mount and the device mount.

26. The portable device mounting apparatus of claim 25, wherein at least the first coupling portion or the second coupling portion is made from a deformable material to facilitate the fit as an interference fit.

27. A portable device mounting apparatus, comprising:
a base mount, wherein the base mount is configured for operative coupling with a support;
a device mount with a portable device coupling, wherein the portable device coupling is configured for operative coupling with a portable device;
a mounting coupling comprising:
a first coupling portion with a first shape and operatively coupled to the base mount;
a second coupling portion with a second shape and operatively coupled to the device mount;
wherein the first shape and the second shape are configured for operatively coupling the device mount to the base mount in a plurality of orientations; and
wherein the device mount is configured for disengagement from a first orientation and engagement in at least a second orientation.

28. The portable device mounting apparatus of claim 27, further comprising:
an attachment member operatively coupled at a first end to the device mount or the portable device, and at a second end to at least one of the base mount, the support, or a user, wherein the attachment member operatively couples the base mount or the portable device to the base mount, the support, or the user during disengagement between the base mount and the device mount.

29. The portable device mounting apparatus of claim 28, wherein the attachment member is a tether.

30. The portable device mounting apparatus of claim 28, wherein the first coupling portion and the second coupling portion further comprise detent components, magnetic components, or frictional surfaces for operatively coupling the base mount to the device mount.

31. The portable device mounting apparatus of claim 28, wherein the first coupling portion or the second coupling portion comprises a tapered edge for creating a fit between the base mount and the device mount.

32. The portable device mounting apparatus of claim 31, wherein at least the first coupling portion or the second coupling portion is made from a deformable material to facilitate the fit as an interference fit.
